(19) United States
(12) Patent Application Publication
(10) Pub. No.: US 2019/0152752 A1
(43) Pub. Date: May 23, 2019

(54) STORAGE AND RETRIEVAL DEVICE

(71) Applicant: Karl Angleitner, Hohenzell (AT)

(72) Inventor: Karl Angleitner, Hohenzell (AT)

(21) Appl. No.: 16/098,377

(22) PCT Filed: Apr. 28, 2017
(86) PCT No.: PCT/AT2017/050009

§ 371 Date: Nov. 1, 2018

(30) Foreign Application Priority Data
May 3, 2016 (AT) A50408/2016

(51) Int. Cl. B66F 9/07

(52) U.S. Cl. CPC B66F 9/072

(57) ABSTRACT

A storage and retrieval device is described having a mast (1) movable along a lower travel rail (3) and an upper guide rail (4), having a lift truck (15) movable along the mast (1) on a lift guide (16), having a mast support (2) arranged on the mast side opposite to the lift truck (15), and having a chassis bearing a running gear for support on the travel rail (3). To provide advantageous construction conditions, it is proposed that the mast (1) and the mast support (2) form the chassis, and the running gear has in each case a running gear group (6, 7) arranged on the mast (1) and on the mast support (2), wherein the two running gear groups (6, 7) are supported in a bearing frame (12) provided on the base of the mast (1) and the mast support (2).

### TECHNICAL AREA

The invention relates to a storage and retrieval device having a mast movable along a lower travel rail and an upper guide rail, having a lift truck movable along the mast on a lift guide, having a mast support arranged on the mast side opposite to the lift truck, and having a chassis bearing a running gear for support on the travel rail.

### PRIOR ART

In a known storage and retrieval device of this type (EP 2 502 873 A1), a chassis supported on a travel rail via a running gear is provided, on which the mast is arranged in a middle section. On the mast side facing away from the chassis end having a traction drive, a mast support is linked between the mast and the chassis end opposite to the traction drive. The lift truck, which is movable along the mast on a lift guide, is located on the side of the chassis facing toward the traction drive, and therefore it can be lowered only down to the chassis and not down into the region of the travel rail. Since the mast is pivotably supported on the chassis and the mast support can be adjusted in its length, the mast can be set in its inclined position. The articulated supporting of the mast and the mast support does prevent a torque transmission from the mast to the chassis, however, the chassis is strained by bending as a result of the superimposed load by the mast and its load, which requires a comparatively heavy chassis construction.

So as not to have to accept the lift restriction of the lift truck by the chassis, in addition (EP 2 589 550 A1), arranging the mast at one end of the chassis and supporting it by a mast support linked at the other chassis end, such that a load accommodation means of the lift truck, which protrudes beyond the chassis and is offset downward, can be lowered below the height level of the chassis, is known. However, the prerequisite for this is a storage and retrieval device which is supported on two travel rails, between which the load means may be lowered accordingly. With the arrangement of the mast in the region of a chassis end, bending torques of the chassis as a result of the weight load by the mast can be substantially avoided, but the bending torques which are transmitted by a torque load of the mast on the chassis have to be absorbed.

In order that a mast inclination in the direction of the shelf aisle caused by the bending strain of the chassis can be avoided, in a storage and retrieval device having two masts, between which the lift truck is guided, it is proposed (EP 0 509314 A1), that the two masts not be supported on a common chassis, but rather each on one chassis, specifically in the middle between the running wheels of the chassis coupled to one another, and therefore a symmetrical bending strain of the chassis with respect to the masts results with the effect that the bending of the girders of the chassis accommodating the masts merely cause a vertical displacement of the masts, but not a mast inclination. However, the chassis have to be designed as correspondingly rigid, in order to be able to absorb the bending torques acting on the masts, which occur in particular during the acceleration and deceleration of the storage and retrieval device in the aisle direction.

### DESCRIPTION OF THE INVENTION

The invention is therefore based on the object of designing a storage and retrieval device movable along a travel rail such that in spite of a comparatively light construction, the occurring loads can advantageously be dissipated to the travel rail and the restrictions otherwise occurring due to a chassis with respect to the lift truck movement do not have to be accepted.

Proceeding from a storage and retrieval device of the type described at the outset, the invention achieves the stated object in that the mast and the mast support form the chassis, and the running gear has in each case one running gear group arranged on the mast and on the mast support, wherein the two running gear groups are supported in a bearing frame provided at the base of the mast and the mast support.

Since a separate chassis is not provided, which in particular absorbs the superimposed loads due to the mast and its strains and dissipates them via the running gear onto the travel rail, but rather the mast and the mast support themselves form the chassis, a significantly lighter and stiffer construction results in relation to the prior art. Because of the omission of a separate chassis, the running wheels of the two running gear groups, which typically also assume the lateral guiding, are to be provided in bearing frames at the base of the mast and the mast support. These bearing frames can be formed in the case of smaller masts by the mast and/or the mast support themselves. In the case of higher demands on the carrying capacity, separate bearing frames can be used, which are inserted, for example, into the base of the mast and/or the mast support. Since the mast and the mast support are therefore each supported as such via running wheels of separate running gear groups in a load-dissipating manner on the travel rail, the bending torques otherwise occurring in the region of the chassis as a result of the mast accommodation and support are avoided. Moreover, the rigidity of the construction is significantly enhanced.

However, dispensing with a separate chassis is not only accompanied by advantages with respect to a construction simplification and a weight savings, but rather also remedies the restriction given by a separate chassis of the travel path of the lift truck as it is lowered into the lowermost position, because the lift truck can be lowered along the mast down to the travel rail. This applies in particular if the lift guide for the lift truck extends below the upper edge of the travel rail for the running gear. In the case of a predefined guide length for the lift truck, the lift guide extended downward in the region of the travel rail means a shorter guide length for the lift truck above the guide rail, which is accompanied by an enlargement of the travel path of the lift truck in the region of the upper guide rail for the mast.

If the mast and the mast support are connected to form a triangular formation, mast and mast support thus form a construction which meets high strength demands, in particular if this triangular formation is stiffened like a framework or is formed by a connecting plate between mast and mast support. A rigid connection between mast and mast support is in no way required, however. Thus, mast and mast support can also be linked in an articulated manner with one another, wherein the spacing between the running gear groups of the mast and the mast support can be adjustable, for example, by a positioning drive, and therefore, inter alia, influence can be taken on the rigidity of the construction via the spacing between the running gear groups of the mast and the mast support. To accelerate the storage and retrieval device, a greater spacing between the running gear groups can thus be selected, which can be kept small in the end region of the shelf aisles.

If a belt drive is provided for the lift truck, its endlessly guided belt can thus be guided via deflection rollers supported in the bearing frame of the mast base to a drive arranged on the bearing frame of the mast support, in order to ensure an advantageous weight distribution due to the displacement of the belt drive to the side of the mast support. Because of the absence of a separate chassis, there is sufficient space present for this purpose between the mast and the mast support.

A tensioning unit is typically provided for tensioning the endlessly guided belt of the belt drive. In order that this tensioning unit does not restrict the travel path of the lift truck in the lower or in the upper end position, one end of the belt can be fastened on a clamping plate connected in a displacement-fixed manner to the lift truck and the other end of the belt drive can be fastened on a clamping plate adjustable in the belt longitudinal direction with the aid of a tensioning drive, wherein the two clamping plates arranged adjacent to one another overlap one another in the belt longitudinal direction, and therefore the space requirement of the tensioning unit in the belt longitudinal direction substantially corresponds to the length of the clamping plates enlarged by the tensioning path.

A wheel drive, in particular a friction wheel drive interacting with the travel rail or a gearwheel drive interacting with a toothed rack associated with the travel rail can be provided in a typical manner for driving the storage and retrieval device along the travel rail. In this case, arranging the wheel drive on the bearing frame of the mast support suggests itself, to achieve a favorable weight distribution between the running wheels of the mast and the mast support. Instead of a wheel drive interacting with the travel rail or a toothed rack, however, the running gear groups associated with the mast, on the one hand, and the mast support, on the other hand, can be connected to a continuous drive extending along the travel rail, with the aid of which the storage and retrieval device can be moved along the travel rail. The span of the continuous drive connecting the two running gear groups to one another can assume the connection between mast base and base of the mast support in this case, because this span of the continuous drive is only strained by tension as a result of the occurring forces between mast and mast support.

To expand the possible uses of a storage and retrieval device according to the invention, the mast support can have a lift guide for a lift truck, in particular if the mast support engages in the region of the upper end on the mast, and therefore the lift truck of the mast support can also store and retrieve on the full height of the shelf, but this is not required.

Finally, in the case of high demands on the carrying capacity on the side of the mast facing away from the mast support, a mast-parallel guide mast connected to the mast by tension or pressure struts can be provided, which is supported via a running gear group on the travel rail and has a lift drive for the lift truck guided between the mast and the guide mast. Since the guide mast essentially only has to absorb the guide forces for the lift truck, a connection to the mast via pressure or tension struts is sufficient, particularly because the proportional weight of the loaded lift truck is dissipated onto the travel rail via the running gear group associated with the guide mast.

### BRIEF DESCRIPTION OF THE INVENTION

The subject matter of the invention is illustrated by way of example in the drawing. In the figures

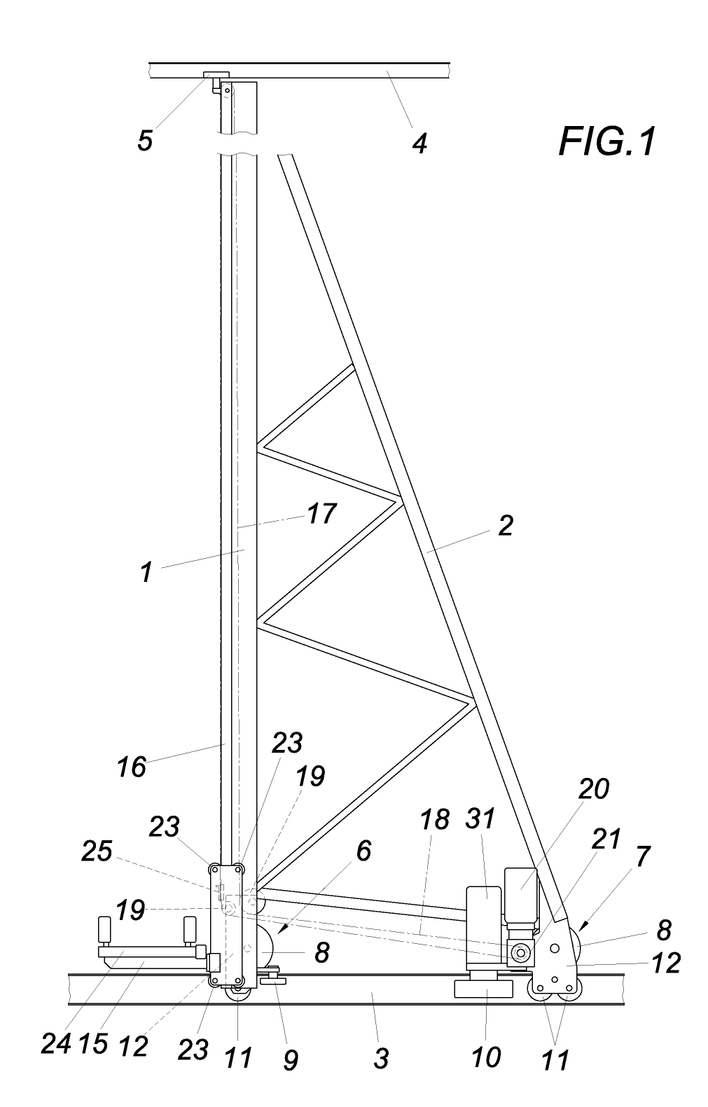

FIG. 1 shows a storage and retrieval device according to the invention in a schematic side view,

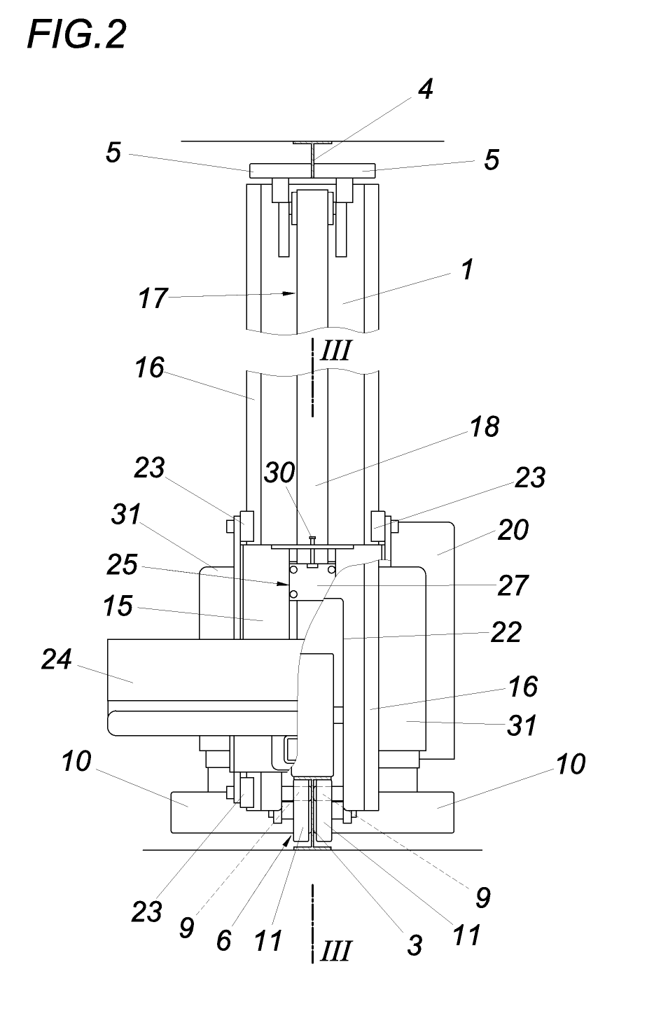

FIG. 2 shows this storage and retrieval device in a partially cutaway frontal view of the end face in a larger scale,

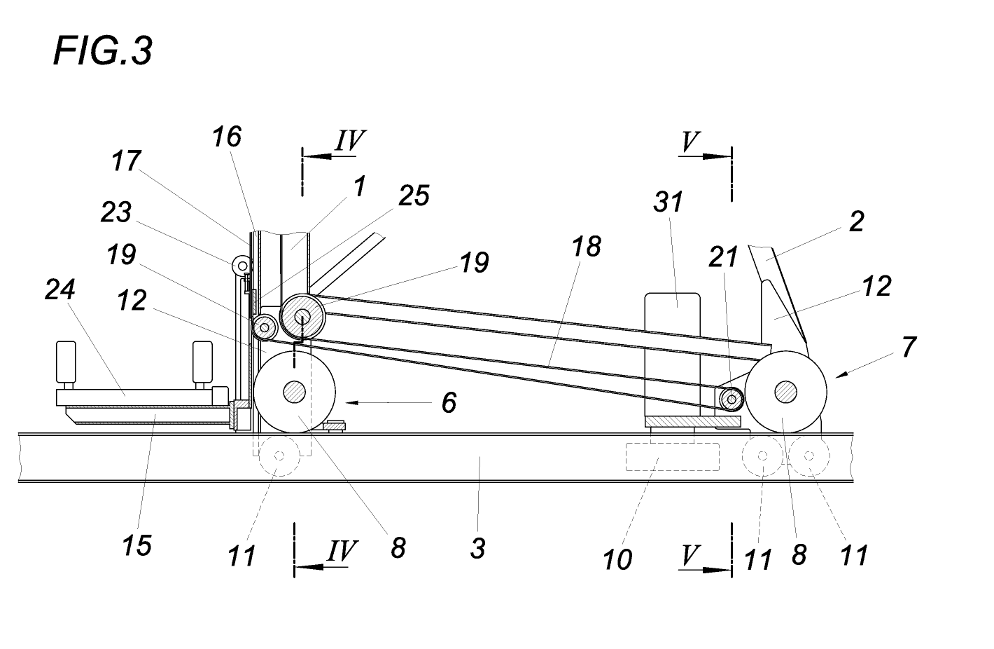

FIG. 3 shows a section along line III-III of FIG. 2 in a smaller scale,

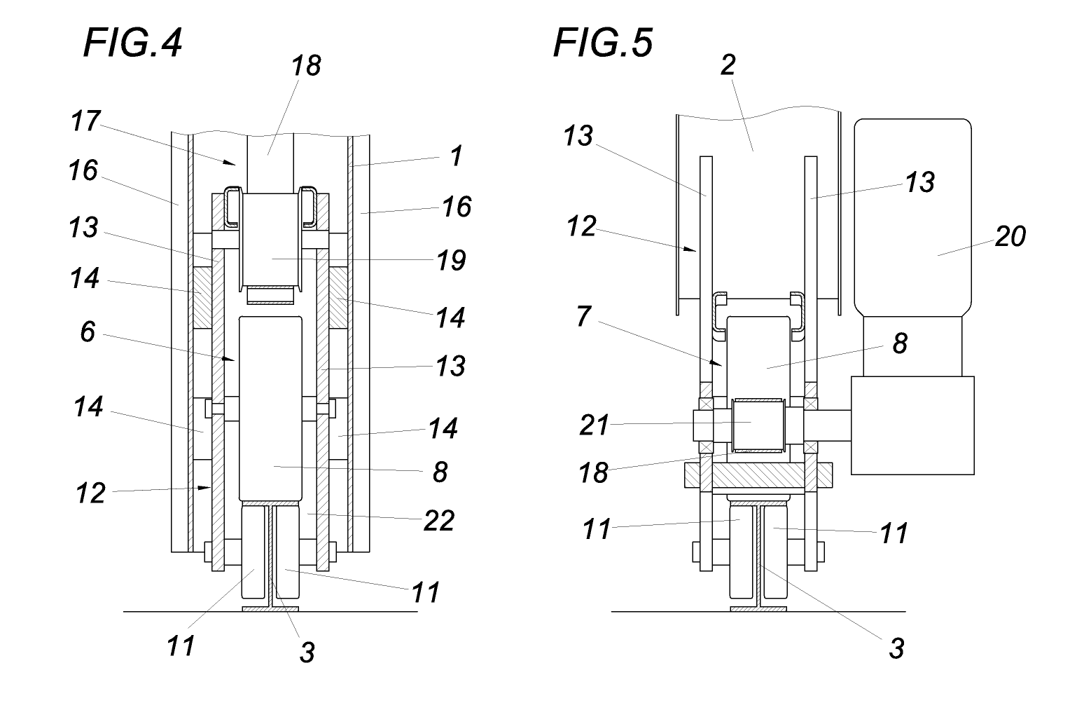

FIG. 4 shows a section along line IV-IV of FIG. 3 in a larger scale,

FIG. 5 shows a section along line V-V of FIG. 3 in a larger scale,

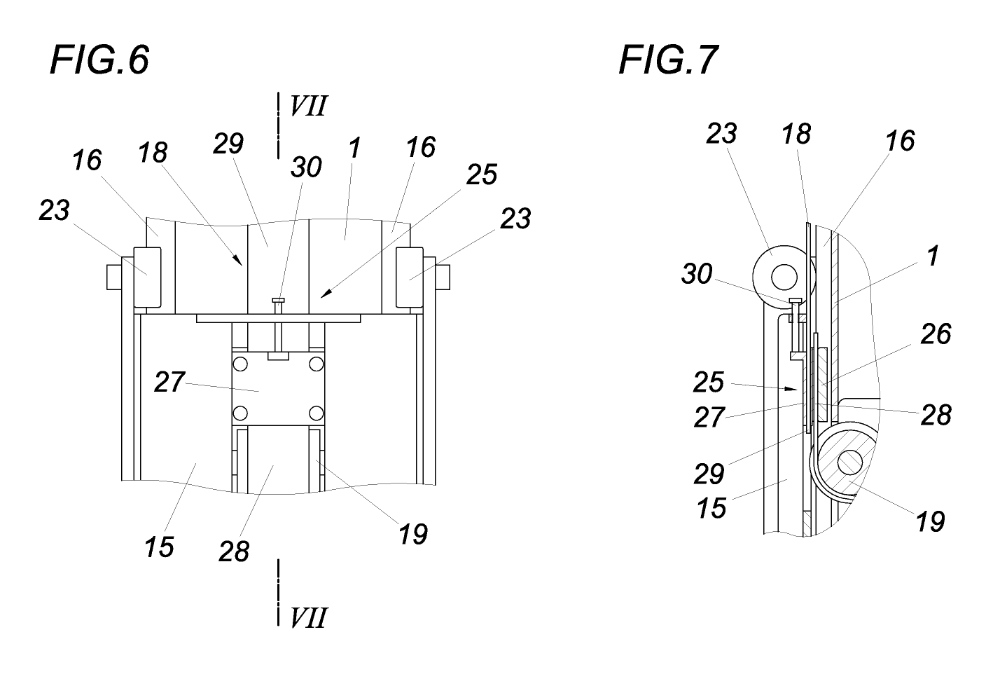

FIG. 6 shows a front view of the end face of the lift truck in the region of the tensioning unit for the belt of the belt drive for the lift truck in a larger scale,

FIG. 7 shows a section along line VII-VII of FIG. 6,

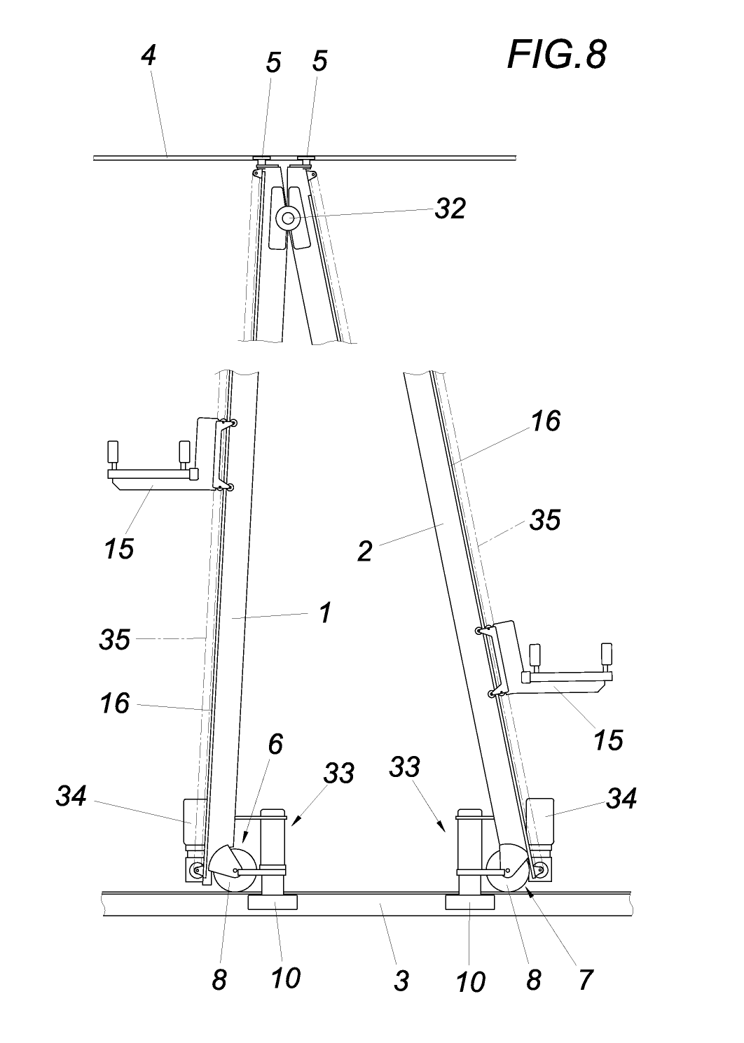

FIG. 8 shows a construction variant of a storage and retrieval device according to the invention in a schematic side view,

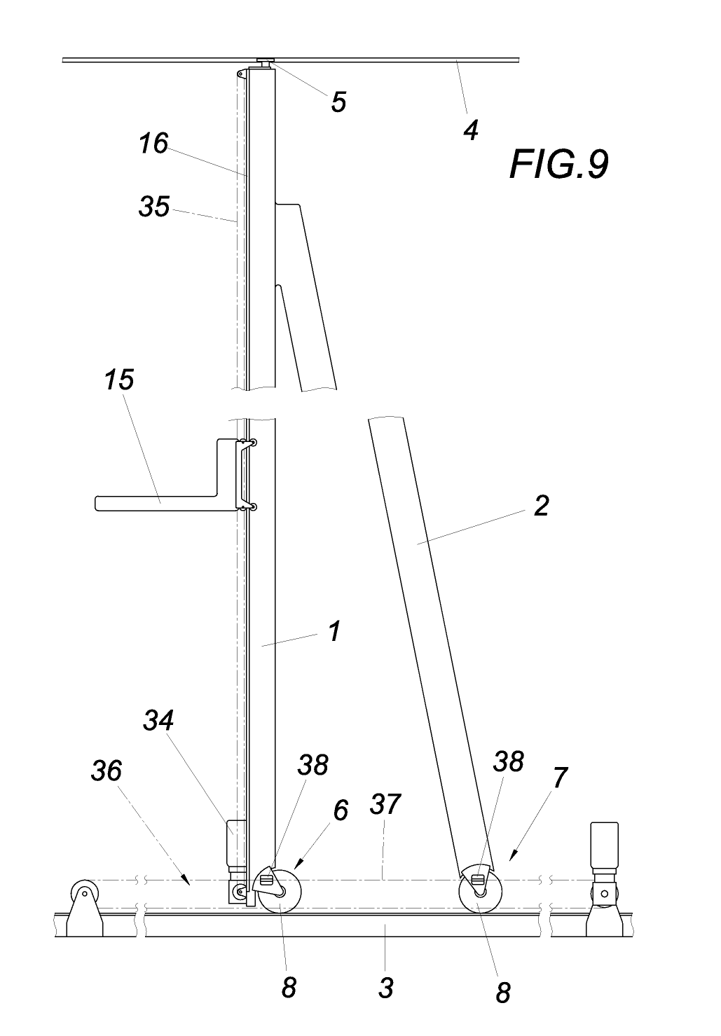

FIG. 9 shows an illustration corresponding to FIG. 8 of a further embodiment of a storage and retrieval device according to the invention, and

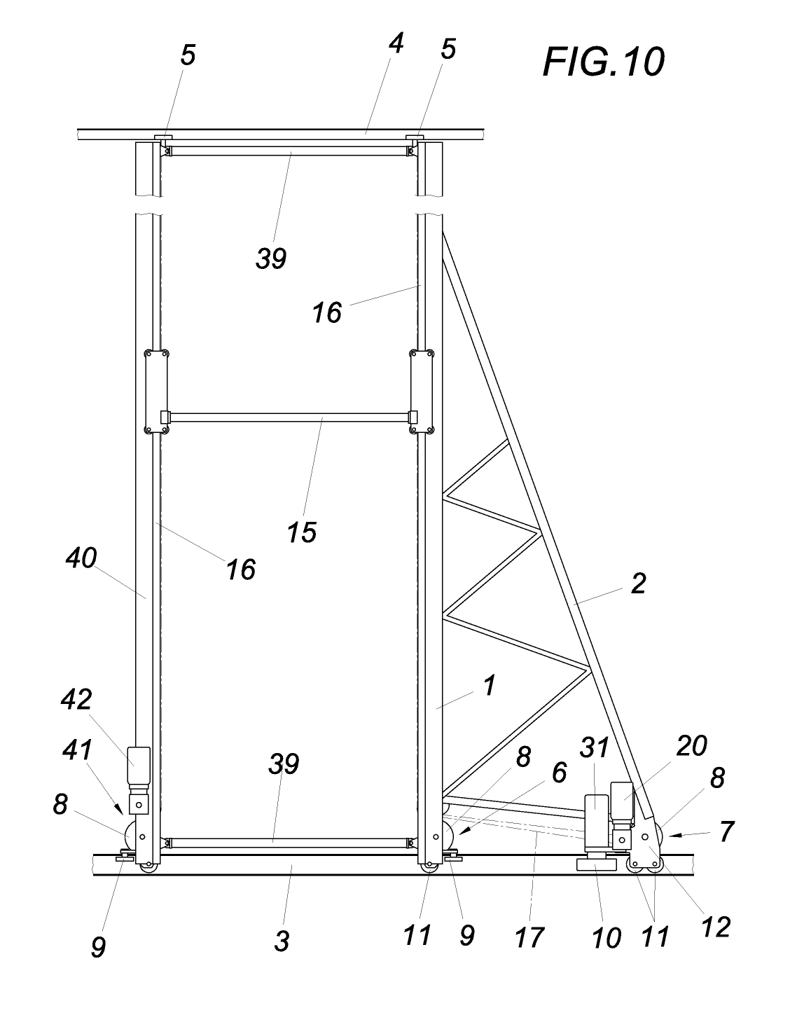

FIG. 10 shows an additional construction variant of a storage and retrieval device according to the invention in a schematic side view.

### WAYS OF EMBODYING THE INVENTION

The storage and retrieval device according to FIGS. 1 to 5 has a mast 1 and a mast support 2, which forms a triangular formation stiffened like a framework with the mast 1. The mast 1 with the mast support 2 is movable along a travel rail 3 and is held in the upper end region by a guide rail 4, specifically with the aid of lateral guide rollers 5. The mast 1 and the mast support 2 form a self-supporting chassis, which is supported in a load-dissipating manner via a running gear on the travel rail 3. This running gear forms two running gear groups 6, 7, which are associated with the mast 1, on the one hand, and the mast support 2, on the other hand, and which comprise a weight-dissipating running wheel 8 and guide rollers 9, 10 laterally applied to the web of the travel rail 3. Moreover, securing rollers 11 are provided, which engage below the runway of the travel rail 3 and prevent lifting of the running gear groups 6, 7 off of the travel rail 3. In the illustrated exemplary embodiment, the running gear groups 6, 7 have bearing frames 12 separate from the mast 1 or from the mast support 2, respectively, in which the running wheel 8, the lateral guide rollers 9, 10, and the securing rollers 11 are supported. The bearing frames 12 are essentially formed according to FIGS. 4 and 5 by two side jaws 13 connected to one another, between which the running rollers 8 and the securing rollers 11 are supported. According to FIG. 4, the bearing frame 12 is inserted into the base of the mast 1, which forms a box profile, via spacers 14. The bearing frame 12 of the mast support 2 is fastened on this mast support 2 by welding, for example.

The lift truck 15 is movable on a lift guide 16 along the mast 1 and can be moved by means of an endless belt drive 17. The arrangement is made in this case such that the belt 18 of the belt drive 17 is guided via deflection rollers 19 supported in the bearing frame 12 of the mast 1 to a drive 20 arranged in the bearing frame 12 of the mast support 2, via which one reflection roller 21 for the toothed belt 18 is driven. Depending on the rotational direction of the drive 20, the lift truck 15 can thus be moved along the lift guide 16 on the mast 1.

As can be inferred from FIG. 4 in particular, the lift guide 16 for the lift carriage 15 extends downward below the upper edge of the runway of the travel rail 3, wherein the profile of the mast 1 has a recess 22 in the region of the guide rail 3. As a result of this lift guide 16, which protrudes downward beyond the travel rail 3, for the lift truck 15, the lift truck 15 according to FIG. 1 can be lowered down to the travel rail 3. To be able to accommodate the load of the lift truck 15, a guide length defined by the spacing of the guide rollers 23 of the lift truck 15 in the direction of the lift guide 16 is to be maintained. Since the lower guide rollers 23 come to rest with spacing below the load support 24 as a result of the described construction conditions, only a section of the guide length is located above the load support, and therefore the lift truck 15 can also assume a better end position in the region of the upper guide rail 4.

A tensioning unit 25 is provided for tensioning the belt 18 of the belt drive 17, which, according to FIGS. 6 and 7, has clamping plates 26 and 27 for the two ends 28 and 29 of the belt 18 to be connected to one another. While the clamping plate 26 for the end 28 of the belt 18 is connected in a displacement-fixed manner to the lift truck 15, the clamping plate 27 for the other end 28 of the belt 18 is guided so it is displaceable in the lift truck 15 in the longitudinal direction of the belt 18 and is supported via a tensioning drive 30, which is preferably designed as a spindle drive and is used to set the belt tension. Since the two clamping plates 26, 27 are arranged adjacent to one another and overlap one another in the longitudinal direction of the belt 18, a structural length results for the tensioning unit 15 in the direction of the belt longitudinal axis substantially restricted to the length of the clamping plates 26, 27 extended by the tensioning path, and therefore the lift truck 15, in spite of the deflection of the belt 18 around the deflection rollers 19, can be lowered down to the travel rail 3 or raised into the region of the upper guide rail 4, respectively.

To drive the chassis formed from the mast 1 and the mast support 2, a wheel gearing is provided, which is designed according to the exemplary embodiment as a friction wheel gearing interacting with the travel rail 3. The lateral guide rollers 10 of the running gear group 7 are laterally pressed as friction rollers against the vertical web of the travel rail 3 and driven via a motor 31.

The exemplary embodiment according to FIGS. 1 to 7 represents an embodiment variant of a storage and retrieval device according to the invention, wherein as a result of the circumstance that a separate chassis is omitted and the mast 1 and the mast support 2 form a self-supporting chassis, which is supported via two running gear groups 6 and 7 on the travel rail 3, for example, a rigid triangular formation between mast 1 and mast support 2 can be omitted. FIG. 8 shows such an embodiment, in which the mast support 2 is linked via an upper joint 32 on the mast 1. Mast 1 and mast support 2 are each supported per se via the running gear groups 6, 7 on the travel rail 3, wherein a separate traction drive 33 is associated with each running gear group 6, 7. These traction drives 33 are illustrated as friction wheel drives having lateral guide rollers 10 and are each controlled per se such that the spacing of the running gear groups 6 and 7 from one another can be set and regulated according to the respective operating conditions. It is therefore possible to change the base of the storage and retrieval device in accordance with the respective requirements.

Moreover, it is indicated in FIG. 8 that not only the mast 1, but rather also the mast support 2, can bear lift guides 16 for a lift truck 15. In this case, controlling each of the two lift trucks 15 as such via separate drives 34 recommends itself, which drives are preferably connected to belt drive 35 for the positioning movement of the lift trucks 15.

The base of a storage and retrieval device according to the invention defined by the spacing of the two running gear groups 6 and 7 can also be established according to FIG. 9 by a continuous drive 36 extending along the travel rail 3 if the two running gear groups 6 and 7 are each fixed on the drive span 37 of the continuous drive 36. Because of the circumstance that the drive span 37 can solely be stressed by tension between the two running gear groups 6 and 7 as a result of the occurring strains of the storage and retrieval device, fixing the base of the storage and retrieval device by the attachment indicated in FIG. 9 to the drive span 37 by tension-fixed connections 38 is sufficient. For the sake of comprehensibility, the running gear groups 6 and 7 are only indicated by the running wheels 8 in FIG. 9.

In order that heavy loads can also be accommodated by the lift truck 15, according to FIG. 10, a mast-parallel guide mast 40 connected to the mast 1 by tension and pressure struts 39 can be provided on the side of the mast 1 facing away from the mast support 2, which guide mast is supported via a running gear group 41 on the travel rail 3 and has a lift drive 42 for the lift truck 15 guided between the mast 1 and the guide mast 40. In this case, synchronization of the lift drive 42 and the drive 20 for the belt drive 17 on the side of the mast 1 is to be ensured. However, a common drive can also be provided for the lift movement of the lift truck 15 on the side of the mast 1 and on the side of the guide mast 40.

1. A storage and retrieval device comprising:
a mast movable along a lower travel rail and an upper guide rail,
a lift truck movable along the mast on a lift guide,
a mast support arranged on a side of the mast opposite to the lift truck, and
the mast and the mast support together forming a chassis bearing a running gear supporting the chassis on the lower travel rail,
wherein the running gear has a running gear group arranged on the mast and on the mast support, respectively, and
wherein the running gear groups are each supported in a respective bearing frame on the base of the mast and the mast support.

2. The storage and retrieval device according to claim 1, wherein the mast and the mast support are connected to form a triangle formation.

3. The storage and retrieval device according to claim 1, wherein the mast and the mast support are linked to each other in an articulated manner, and spacing between the running gear groups of the mast and the mast support is adjustable.

4. The storage and retrieval device according to claim 1, wherein the lift guide for the lift truck extends below an upper edge of the lower travel rail for the running gear.

5. The storage and retrieval device according to claim 1, wherein the lift truck has a belt drive, wherein the belt drive has an endlessly guided belt that is guided via deflection rollers supported in the bearing frame of the mast base to a drive arranged on the bearing frame of the mast support.

6. The storage and retrieval device according to claim 5, wherein an end of the belt of the belt drive is fastened on a clamping plate connected in a displacement-fixed manner to the lift truck and an opposite end of the belt drive is fastened on a clamping plate adjustable using a tensioning drive in a longitudinal direction of the belt, and two clamping plates arranged adjacent to one another overlap one another in the longitudinal direction.

7. The storage and retrieval device according to claim 1, wherein the running gear comprises a wheel drive arranged on the bearing frame of the mast support and interacting with the travel rail.

8. The storage and retrieval device according to claim 1, wherein the running gear groups arranged on the mast and on the mast support are attached to a continuous drive extending along the lower travel rail.

9. The storage and retrieval device according to claim 1, wherein the mast support has a second lift guide for a lift truck.

10. The storage and retrieval device according to claim 1, wherein a mast-parallel guide mast connected to the mast by tension or pressure struts is provided on another side of the mast facing away from the mast support, and said guide mast is supported via a third running gear group on the lower travel rail and has a lift drive for the lift truck guided between the mast and the guide mast.
